(19) United States
(12) Patent Application Publication
(10) Pub. No.: US 2008/0293645 A1
(43) Pub. Date: Nov. 27, 2008

(54) Antiparasitic combination and method for treating domestic animals

(76) Inventor: Lawrence F. Schneider, Sleepy Hollow, IL (US)

Correspondence Address: PAULEY PETERSEN & ERICKSON, 2800 WEST HIGGINS ROAD, SUITE 365, HOFFMAN ESTATES, IL, 60195, US

(21) Appl. No.: 11/807,050

(22) Filed: May 25, 2007

(51) Int. Cl. A01N 43/60; A01N 43/08; A01N 43/16; A01N 43/90; A01P 7/02; A01P 7/04; A01P 7/00; A01N 43/78; A01N 43/54

(52) U.S. Cl. 514/28; 514/250; 514/255.05; 514/368

(57) ABSTRACT

This invention relates an antiparasitic combination for conveniently treating multiple types of parasites in domestic animals. Specifically, this invention provides a convenient combination and a method for removing worms from a gastrointestinal tract of a domestic animal while also preventing heartworm. The antiparasitic combination for the treatment of domestic animals may include an effective amount of praziquantel, an effective amount of pyrantel pamoate, an effective amount of febantel, and an effective amount of ivermectin. Typical worms removed may include tapeworms, hookworms, whipworms and ascarids.

### BACKGROUND OF THE INVENTION

1. Field of the Invention

This invention relates an antiparasitic combination for the removal of hookworms, tapeworms, whipworms, ascarids and the prevention of heartworms in domestic animals.

2. Description of Related Art

The anthelmintic properties of certain compounds have been used alone or in limited combinations. Phenylguanidines and benzimidazoles are active against ascarids, whipworms and to some extent hookworms. Tetrahydropyrimidines are active against ascarids and to some extent hookworms. The combination of praziquantel (a hexahydropyrazinoisoquinolone) and pyrantel (a tetrahydropyrimidine) may be employed against parasites of the small intestines in some vertebrates.

The use of certain compounds for prevention of heartworms has been demonstrated, such as avermectins.

There are no known combinations of compounds having both full spectrum anthelmintic properties and also capable of preventing heartworms as may be conveniently desired by veterinarians, domestic animal owners and the like.

### SUMMARY OF THE INVENTION

Accordingly, it is one object of this invention to provide an antiparasitic combination for conveniently treating and/or preventing multiple types of parasites in domestic animals. Specifically, this invention provides a convenient combination and a method for removing parasites from a gastrointestinal tract of a domestic animal while also preventing heartworms.

These and other objects of this invention are addressed by an antiparasitic combination for the treatment of domestic animals including an effective amount of praziquantel, an effective amount of pyrantel pamoate, an effective amount of febantel, and an effective amount of ivermectin. Specifically the antiparasitic combination may be useful for removal of tapeworms, hookworms, whipworms, and ascarids; and prevention of heartworms in canines.

Tapeworms may include Dipylidium caninum, Taenia pisiformis, Echinococcus granulosus, and Echinococcus multilocularis. Hookworms may include Ancylostoma caninum, Ucinaria stenocephala, and Ancylostoma braziliense. Ascarids may include Toxocara canis and Toxascaris leonina. Whipworms may include Trichuris vulpis. Heartworms may include Dirofilaria immitis.

The effective amounts may include at least about 5 milligrams of praziquantel per kilogram of a mass of the domestic animal, at least about 5 milligrams of pyrantel base (as pyrantel pamoate) per kilogram of the mass of the domestic animal, at least about 25 milligrams of febantel per kilogram of the mass of the domestic animal, and at least about 6.0 micrograms of ivermectin per kilogram of the mass of the domestic animal.

Praziquantel may constitute between about 5 weight percent to about 30 weight percent of the antiparasitic combination, desirably about 14.28 weight percent. Pyrantel base (as pyrantel pamoate) may constitute between about 5 weight percent to about 30 weight percent of the antiparasitic combination, desirably about 14.28 weight percent. Febantel may constitute between about 50 weight percent to about 85 weight percent of the antiparasitic combination, desirably about 71.41 weight percent. Ivermectin may constitute between about 0.005 weight percent to about 5 weight percent of the antiparasitic combination, desirably about 0.03 weight percent.

The invention may also include different dosages for different sized domestic animals, such as, for example, small, medium, and large dogs. For a small domestic animal, the dosage may include about 23 milligrams of praziquantel, about 23 milligrams of pyrantel base (as pyrantel pamoate), about 113 milligrams of febantel, and about 68 micrograms of ivermectin. For a medium domestic animal, the dosage may include about 68 milligrams of praziquantel, about 68 milligrams of pyrantel base (as pyrantel pamoate), about 340 milligrams of febantel, and about 136 micrograms of ivermectin. For a large domestic animal, the dosage may include about 136 milligrams of praziquantel, about 136 milligrams of pyrantel base (as pyrantel pamoate), about 680 milligrams of febantel, and about 272 micrograms of ivermectin.

Suitable delivery forms for the combination may include a compressed tablet, a compressed chewable tablet, a soft-chew molded bolus, an extruded chewable bolus, a soft-chew molded chewable tablet, an extruded chewable tablet, a palatable paste, a suspension, a liquid solution and a powder. Dosages may include effective amounts administered at about 30 day intervals.

The invention may further include binding agents, flavor agents, lubricating agents, flow agents, disintegration agents, delay agents, encapsulant and/or densifying agents and combinations thereof.

This invention also includes methods of treating parasites in domestic animals having one or more parasites. Treating may include removing tapeworms, hookworms, whipworms, and ascarids and preventing heartworms. The method may include administering a combination having an effective amount of praziquantel, an effective amount of pyrantel pamoate, an effective amount of febantel, and an effective amount of ivermectin.

The method may include administering by oral methods, such as by a chewable tablet. Desirably the method may include administering from about 0.5 antiparasitic chewable tablets to about 3.0 antiparasitic chewable tablets based on a mass of the domestic animal. Generally, the antiparasitic combination is administered once about every 30 days to a domestic animal which may be a canine.

### DETAILED DESCRIPTION OF THE PREFERRED EMBODIMENTS

This invention is used for the treatment of parasites in domestic animals. Parasites broadly may include single celled organisms to higher level or more complex creatures that at least in part exist or derive subsistence from a host. Parasites broadly may include organisms that for at least a part of their life cycle live near, on or in the host. Endoparasites may often include those parasites that are within at least a portion of the host, such as, for example, within a gastrointestinal tract of the host.

Non-human hosts may broadly include other organisms than the parasite and broadly may include air, aquatic, surface, and subterranean dwelling animals capable of aerobic and/or anaerobic cellular respiration. Domestic animals may include those animals that in at least some manner have been tamed, reproduced, raised or any other suitable action by humans. Animals subject to veterinary practices and/or animal husbandry practices may be suitable domestic animals, such as, for example, horses, cattle, fowl or poultry, rabbits, birds, felines or cats, canines or dogs, and any other suitable living creature. According to a preferred embodiment of this invention, domestic animals include canines.

A more specific kind of parasite may include various types of worms. Worms broadly may include parasites having a length greater than a width, such as, for example, forming a generally tubular shaped body structure or shape. Common types of parasitic worms may include, without limitation, hookworms, whipworms, roundworms, tapeworms, ascarids, heartworms and any other similar parasite. Worms may sometimes be described as helminths.

Tapeworms generally may include flatworms called cestodes or the class Cestoda which may live in the digestive tract of vertebrates. Some specific tapeworms may include Dipylidium caninum, Taenia pisiformis, Echinococcus granulosus, Echinococcus multilocularis and any other similar worm of the same class or subclass.

Hookworms generally may include relatively smaller worms called nematodes or the class Nematoda that may live in the small intestines of mammals. Some specific hookworms may include Ancylostoma caninum, Ucinaria stenocephala, Ancylostoma braziliense and any other similar worm of the same class or subclass. Hookworms may particularly have dogs, cats and/or human hosts.

Ascarids generally may include roundworms that may live in the small intestines of mammals. Some specific ascarids may include Toxocara canis, Toxascaris leonina and any other similar worm of the same class or subclass.

Whipworms generally may include roundworms that typically reside within the large intestines of mammals. Some specific whipworms may include Trichuris vulpis and any other similar worm of the same class or subclass.

Heartworms generally may include roundworms that typically reside within the heart of a host during the final reproductive stages of its life cycle. Some specific heartworms may include Dirofilaria immitis and any other similar worm of the same class or subclass.

Antiparasitics typically may include characteristics or qualities of preventing, treating, removing or eliminating, controlling or mitigating, reducing or lowering the infestation of parasites from a host permanently or for at least a period between treatments or dosages. Sometimes these compounds may be referred to as parasiticides. Specific compounds for worms are sometimes referred to as anthelmintics or dewormers.

Infestations of parasites in domestic animals may typically include one or more of the same worms living within the host. Sometimes more than one type of worm may live within the same host.

Combination as used herein broadly may include two or more elements or compounds physically, chemically, and/or otherwise suitably coupled with each other to produce a desired result. According to a preferred embodiment of this invention, the combination includes at least four active components.

Active components may include those elements and/or compounds having treatment or therapeutic effect either individually and/or synergistically with other active components of the combination.

Effective amounts may include a suitably adequate quantity of an item to produce a treatment or therapeutic effect. According to a preferred embodiment of this invention, the effective amount has antiparasitic qualities. Desirably, the antiparasitic combination is useful for removal of tapeworms, hookworms, whipworms and ascarids; and the antiparasitic combination is useful for prevention of heartworms. Preventing generally includes prophylactic measures.

According to a preferred embodiment of this invention, the antiparasitic combination for the treatment of domestic animals may include an effective amount of praziquantel, an effective amount of pyrantel pamoate, an effective amount of febantel, and an effective amount of ivermectin. Other combinations of additional antiparasitic compounds may be possible. Combinations of other therapeutic items may be possible, such as, for example, a combination for treating parasites and improving bone density.

Praziquantel may generally assist in the removal and/or control of tapeworms. Pyrantel pamoate may generally assist in the removal and/or control of hookworms and ascarids. Febantel may generally assist in the removal of whipworms. Ivermectin may generally assist in the prevention of heartworms by eliminating the tissue stage of the heartworm larvae.

Desirably, effective amounts of active components may be varied based on factors particular to the subject being treated, such as, for example, type of parasite, extent of infestation, size of the domestic animal, age of the domestic animal and any other suitable criteria that may affect the treatment. According to a preferred embodiment of this invention, the effective amounts of active components are based on a mass of the domestic animal.

Desirably, the effective amount of praziquantel is at least about 5 milligrams of praziquantel per kilogram of the mass of the domestic animal; the effective amount of pyrantel base (as pyrantel pamoate) is at least about 5 milligrams of pyrantel base (as pyrantel pamoate) per kilogram of the mass of the domestic animal; the effective amount of febantel is at least about 25 milligrams of febantel per kilogram of the mass of the domestic animal; and the effective amount of ivermectin is at least about 6.0 micrograms of ivermectin per kilogram of the mass of the domestic animal.

Effective amounts of praziquantel may constitute between about 0 weight percent to about 50 weight percent of the antiparasitic combination, suitably between about 5 weight percent to about 30 weight percent, desirably between about 10 weight percent to about 20 weight percent. According to a preferred embodiment of this invention, the antiparasitic combination includes about 14.28 weight percent of praziquantel.

Effective amounts of pyrantel base (as pyrantel pamoate) may constitute between about 0 weight percent to about 50 weight percent of the antiparasitic combination, suitably between about 5 weight percent to about 30 weight percent, desirably between about 10 weight percent to about 20 weight percent. The inclusion of the pyrantel pamoate salt may improve efficacy since other salts of pyrantel such as the tartrate may be more water soluble and absorbed out of the GI tract. Desirably, the pamoate salt makes the pyrantel water insoluble, which allows activity in the lumen of the gastrointestinal tract. According to a preferred embodiment of this invention, the antiparasitic combination includes about 14.28 weight percent of pyrantel base (as pyrantel pamoate).

Effective amounts of febantel may constitute between about 0 weight percent to about 95 weight percent of the antiparasitic combination, suitably between about 50 weight percent to about 85 weight percent, desirably between about 65 weight percent to about 75 weight percent. According to a preferred embodiment of this invention, the antiparasitic combination includes about 71.41 weight percent of febantel.

Effective amounts of ivermectin may constitute between about 0 weight percent to about 15 weight percent of the antiparasitic combination, suitably between about 0.005 weight percent to about 5 weight percent, desirably between about 0.01 weight percent to about 1 weight percent. According to a preferred embodiment of this invention, the antiparasitic combination includes about 0.03 weight percent of ivermectin.

The antiparasitic combination may be delivered in a variety of forms, such as, for example, intravenously, topically, follically, dermally, orally, and any other suitable method of administering active components or agents to the host and/or to the parasite. Oral methods may include a compressed tablet, a compressed chewable tablet, a soft-chew molded bolus, an extruded chewable bolus, a soft-chew molded chewable tablet, an extruded chewable tablet, a palatable paste, a suspension, a liquid solution, emulsion, and a powder. According to a preferred embodiment of this invention, the delivery form is a compressed chewable tablet.

Desirably, various dosages are supplied to facilitate convenience when administering the combination, such as, for example, tablets or pills for small, medium, and large domestic animals. Small domestic animals may include new or young animals, such as, for example, puppies or kittens. Preferably, young animals may be a few weeks old before administering the antiparasitic combination. Typically, small domestic animals may include a mass of up to about 11 kilograms, medium domestic animals may include a mass of about 11 kilograms to about 25 kilograms, and large domestic animals may include a mass of about 25 kilograms to about 45 kilograms.

According to a preferred embodiment of this invention, the dosage form and amount includes an antiparasitic chewable tablet including effective amounts for a small domestic animal with about 23 milligrams of praziquantel, about 23 milligrams of pyrantel base (as pyrantel pamoate), about 113 milligrams of febantel and about 68 micrograms of ivermectin.

Similarly, an antiparasitic chewable tablet for a medium domestic animal of may include about 68 milligrams of praziquantel, about 68 milligrams of pyrantel base (as pyrantel pamoate), about 340 milligrams of febantel, and about 136 micrograms of ivermectin. An antiparasitic chewable tablet for a large domestic animal may include about 136 milligrams of praziquantel, about 136 milligrams of pyrantel base (as pyrantel pamoate), about 680 milligrams of febantel, and about 272 micrograms of ivermectin.

A dose generally may include an effective amount of active components administered to the domestic animal. Desirably, the delivery form readily and conveniently accommodates needed dosage quantities by allowing volume adjustment, such as, for example, fractions of or multiple tablets, metering a volume of a liquid solution, or any other suitable procedure for increasing and/or decreasing the effective amount of active components based on the factors of the domestic animal.

The effective amount desirably will last or be effective for a duration. Typically, active components of the combination are delivered or dosed in a calculated manner to produce a therapeutic effect for a substantially similar time or duration, such as, for example, for a week, two months, or any other suitable time frame. Desirably, the removal of worms from the gastrointestinal tract and the prevention of heartworms lasts for substantially the same period of time. According to a preferred embodiment of this invention, the dose is effective for about thirty days or one month after given to the domestic animal.

The antiparasitic combination may further include flavor agents, lubricating agents, flow agents, disintegration agents, delay agents, encapsulant and/or densifying agents and any other suitable inactive substances.

Binding agents typically may include starch, modified starch, cellulose, modified cellulose, brewer's yeast, sucrose, dextrose, whey, dicalcium phosphate and any other suitable material to hold or form the active components.

Flavoring agents typically may include dried liver, liver extract, cheese, cheese products, natural flavors, artificial flavors, milk flavored products, soybean flavored products, brewer's yeast and any other suitable taste enhancing material.

Lubricating agents typically may include magnesium stearate, stearic acid, starch, modified starch, modified cellulose, and any other suitable material to facilitate tablet or bolus compaction.

Flow agents typically may include silica dioxide, modified silica, fumed silica, talc and any other suitable material to assist bulk movement of active components and/or the combination during delivery and/or manufacture.

Disintegration agents typically may include croscarmellose sodium, sodium starch glycolate, starch, modified starch and any other suitable material to help breakdown the dosage form and to assist in delivery of active components.

Delay agents typically may include stearic acid, stearic acid salts, magnesium stearate, polyethylene glycols, starch, modified starch, methacrylate polymers and any other suitable material to slow down the release and/or absorption of active components.

Encapsulant and/or densifying agents may selectively control where in a gastrointestinal tract of the domestic animal the active ingredient becomes available, such as for example after the stomach and in the small intestines. Typical encapsulant and/or densifying pharmapolymer agents may include methacrylate polymers, hydroxypropyl cellulose, hydroxypropyl methylcellulose and any other suitable material dissolvable within specific parts of the gastrointestinal tract of the domestic animal. According to a preferred embodiment of this invention, at least one active ingredient is coated with an encapsulant and/or densifying agent. Selectively coating some active components may improve efficacy and/or reduce interactions among active components.

This invention also includes a method of treating parasites in domestic animals. Administering typically includes providing or giving a sufficient dosage to the domestic animal to have a therapeutic effect. According to a preferred embodiment of this invention, the method for treating parasites in domestic animals having parasites includes administering a combination having of an effective amount of praziquantel, an effective amount of pyrantel pamoate, an effective amount of febantel, and an effective amount of ivermectin. The advantage of a combination is that it can be effective in domestic animals having more than one type or kind of parasite. This full or broad spectrum treatment may be convenient for the person administering the treatment, such as, for example, a veterinarian or a dog owner.

Desirably the method includes oral methods for administering the antiparasitic combination. According to a preferred embodiment of this invention, the oral methods include chewable tablets. Desirably, the method includes convenient forms for administering the treatment, such as, for example, administering from about 0.5 antiparasitic chewable tablets to about 3.0 antiparasitic chewable tablets based on a mass of the domestic animal.

For example and without limitation, a person owns a 13-kilogram poodle that has contracted parasites by eating or ingesting a contaminated food source. The poodle has hookworms and whipworms as indicated by diarrhea, intestinal cramping, and malnutrition. The poodle also soon may romp outdoors during warm weather in areas with mosquitoes capable of transmitting heartworms. The owner takes the poodle to the veterinarian who prescribes the antiparasitic combination of this invention in a convenient flavored chewable tablet form. The veterinarian consults the product information and determines that the poodle is a medium domestic animal so the proper tablets for medium animals are selected. The veterinarian then determines that the 13-kilogram poodle requires only one medium tablet per dose which is effective for 30 days.

The veterinarian asks the owner if the poodle would prefer cheese or liver flavored tablets. The owner responds that the poodle really likes liver. One liver flavored tablet is given to the poodle by the hand of the veterinarian and the poodle readily ingests the flavored tablet with the antiparasitic combination. The veterinarian gives six additional tablets to the owner for administering one a month until consumed. The poodle soon has a bowel movement where the hookworms and the whipworms are excreted from the gastrointestinal tract and the symptoms subside. The poodle also enjoys the outdoors while being protected against heartworm.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. An antiparasitic combination for the treatment of domestic animals comprising:
an effective amount of praziquantel;
an effective amount of pyrantel base (as pyrantel pamoate);
an effective amount of febantel; and
an effective amount of ivermectin.

2. The antiparasitic combination of claim 1, wherein:
the effective amount of praziquantel is at least about 5 milligrams of praziquantel per kilogram of a mass of the domestic animal;
an effective amount of pyrantel base (as pyrantel pamoate) is at least about 5 milligrams of pyrantel pamoate per kilogram of the mass of the domestic animal;
an effective amount of febantel is at least about 25 milligrams of febantel per kilogram of the mass of the domestic animal; and
an effective amount of ivermectin is at least about 6.0 micrograms of ivermectin per kilogram of the mass of the domestic animal.

3. The antiparasitic combination of claim 1, further comprising a delivery form selected from the group consisting of a compressed tablet, a compressed chewable tablet, a soft-chew molded bolus, an extruded chewable bolus, a soft-chew molded chewable tablet, an extruded chewable tablet, a palatable paste, a suspension, a liquid solution, and a powder.

4. The antiparasitic combination of claim 1, wherein:
the antiparasitic combination is useful for removal of tapeworms, hookworms, whipworms, and ascarids; and
the antiparasitic combination is useful for prevention of heartworms.

5. The antiparasitic combination of claim 4, wherein the antiparasitic combination is useful for at least about 30 days for each dose administered to the domestic animal.

6. The antiparasitic combination of claim 4, wherein:
the tapeworms include at least one of Dipylidium caninum, Taenia pisiformis, Echinococcus granulosus, and Echinococcus multilocularis;
the hookworms include at least one of Ancylostoma caninum, Ucinaria stenocephala, and Ancylostoma braziliense;
the ascarids include at least one of Toxocara canis and Toxascaris leonina;
the whipworns include Trichuris vulpis; and
the heartworms include Dirofilaria immitis.

7. The antiparasitic combination of claim 1, further comprising one of the group consisting of binding agents, flavor agents, lubricating agents, flow agents, disintegration agents, delay agents, and combinations thereof.

8. The antiparasitic combination of claim 7, wherein the binding agent is selected from the group consisting of starch, modified starch, cellulose, modified cellulose, brewer's yeast, sucrose, dextrose, whey, dicalcium phosphate, and combinations thereof.

9. The antiparasitic combination of claim 7, wherein the flavoring agent is selected from the group consisting of dried liver, liver extract, cheese, cheese products, natural flavors, artificial flavors, milk flavored products, soybean flavored products, brewer's yeast, and combinations thereof.

10. The antiparasitic combination of claim 7, wherein the lubricating agent is selected from the group consisting of magnesium stearate, stearic acid, starch, modified starch, modified cellulose, and combinations thereof.

11. The antiparasitic combination of claim 7, wherein the flow agent is selected from the group consisting of silica dioxide, modified silica, fumed silica, talc, and combinations thereof.

12. The antiparasitic combination of claim 7, wherein the disintegration agent is selected from the group consisting of croscarmellose sodium, sodium starch glycolate, starch, modified starch, and combinations thereof.

13. The antiparasitic combination of claim 7, wherein the delay agent is selected from the group consisting of stearic acid, stearic acid salts, magnesium stearate, polyethylene glycols, starch, modified starch, methacrylate polymers, and combinations thereof.

14. The antiparasitic combination of claim 1, wherein the domestic animals are canines.

15. The antiparasitic combination of claim 1, wherein at least one active ingredient of the group consisting praziquantel, pyrantel pamoate, febantel, and ivermectin is coated with an encapsulant agent.

16. The antiparasitic combination of claim 15, wherein the encapsulant agent selectively controls where in a gastrointestinal tract of the domestic animal the active ingredient becomes available.

17. The antiparasitic combination of claim 15, wherein the encapsulant agent is selected from the group consisting of methacrylate polymers, hydroxypropyl cellulose, hydroxypropyl methylcellulose and combinations thereof.

18. An antiparasitic chewable tablet comprising:
effective amounts of praziquantel, pyrantel pamoate, febantel, and ivermectin; and
a flavoring agent.

19. The antiparasitic chewable tablet of claim 18, wherein the effective amounts include sufficient dosages for about 30 days.

20. The antiparasitic chewable tablet of claim 18, wherein effective amounts for active components of the antiparasitic combination include:
between about 5 weight percent to about 30 weight percent of praziquantel;
between about 5 weight percent to about 30 weight percent of pyrantel base (as pyrantel pamoate);
between about 50 weight percent to about 85 weight percent of febantel; and
between about 0.005 weight percent to about 5 weight percent of ivermectin.

21. The antiparasitic chewable tablet of claim 18, wherein effective amounts for active components of the antiparasitic combination include:
about 14.28 weight percent of praziquantel;
about 14.28 weight percent of pyrantel base (as pyrantel pamoate);
about 71.41 weight percent of febantel; and
about 0.03 weight percent of ivermectin.

22. The antiparasitic chewable tablet of claim 18, wherein effective amounts for a small domestic animal include:
about 23 milligrams of praziquantel;
about 23 milligrams of pyrantel base as (pyrantel pamoate);
about 113 milligrams of febantel; and
about 68 micrograms of ivermectin.

23. The antiparasitic chewable tablet of claim 18, wherein effective amounts for a medium domestic animal include:
about 68 milligrams of praziquantel;
about 68 milligrams of pyrantel base (as pyrantel pamoate);
about 340 milligrams of febantel; and
about 136 micrograms of ivermectin.

24. The antiparasitic chewable tablet of claim 18, wherein effective amounts for a large domestic animal include:
about 136 milligrams of praziquantel;
about 136 milligrams of pyrantel base (as pyrantel pamoate);
about 680 milligrams of febantel; and
about 272 micrograms of ivermectin.

25. A method for treating parasites in domestic animals having one or more parasites comprising administering a combination having of an effective amount of praziquantel, an effective amount of pyrantel base (as pyrantel pamoate), an effective amount of febantel, and an effective amount of ivermectin.

26. The method of claim 25, wherein:
the effective amount of praziquantel is at least about 5 milligrams of praziquantel per kilogram of a mass of the domestic animal;
an effective amount of pyrantel base (as pyrantel pamoate) is at least about 5 milligrams of pyrantel pamoate (as pyrantel pamoate) per kilogram of the mass of the domestic animal;
an effective amount of febantel is at least about 25 milligrams of febantel per kilogram of the mass of the domestic animal; and
an effective amount of ivermectin is at least about 6.0 micrograms of ivermectin per kilogram of the mass of the domestic animal.

27. The method of claim 25, wherein the administering includes oral methods.

28. The method of claim 27, wherein the oral methods include chewable tablets.

29. The method of claim 27, wherein the administering includes from about 0.5 antiparasitic chewable tablets to about 3.0 antiparasitic chewable tablets based on a mass of the domestic animal.

30. The method of claim 25, wherein the combination is administered once about every 30 days.

31. The method of claim 25, wherein the domestic animal is a canine.

32. The method of claim 25, wherein the treating includes:
removing tapeworms, hookworms, whipworms, and ascarids; and
preventing heartworms.
